(19) United States
(12) Patent Application Publication
(10) Pub. No.: US 2025/0167476 A1
(43) Pub. Date: May 22, 2025

(54) Coaxial connector

(71) Applicant: Coax Connectors Ltd., Twickenham (GB)

(72) Inventors: Phill Skingsley, Twickenham (GB); Gary Elmes, Twickenham (GB)

(73) Assignee: Coax Connectors Ltd., Twickenham (GB)

(21) Appl. No.: 18/906,798

(22) Filed: Oct. 4, 2024

(30) Foreign Application Priority Data
Oct. 6, 2023 (GB) 2315392.7

(51) Int. Cl. H01R 13/35; H01R 13/50; H01R 13/516; H01R 101/00

(52) U.S. Cl. CPC H01R 13/35; H01R 13/50; H01R 13/516; H01R 2101/00

(57) ABSTRACT

A coaxial connector comprising a body, which comprises an opening and a front portion for engaging with a corresponding connector, and a centre contact received within the opening of the body and supported by an insulator, wherein the insulator comprises an inner part comprising an opening defining an inner surface of the inner part that contacts an outer surface of the centre contact, and an outer part comprising an opening defining an inner surface of the outer part that contacts an outer surface of the inner part.

The present disclosure relates to a coaxial connector, in particular to a coaxial connector comprising a multi-part insulator.

Typically, when trying to design a 75 Ohm RF connector, the starting point is the existing 50 Ohm version, wherein all dimensions to allow intermating are specified by connector specifications such as BS EN 61169.

Usually, to change a 50 Ohm design to a 75 Ohm, the centre contact diameter is reduced whilst leaving the critical external/outer contact size unchanged, so as to accord with the specification dimensions.

The standard equation for the impedance of a coaxial line is given by.

$${Z}_{0} = \frac{138}{\sqrt{{ε}_{r}}} log ( \frac{D}{d} ) ( ohms )$$

So, taking, as an example, an outside contact diameter (D) of 4.02 mm and a PTFE (Teflon) Insulator (εᵣ=2.1), a centre contact diameter (d) of 1.2 mm would be required to make it (Zo) 50 Ohm.

To turn this into a 75 Ohm connector you would just need to reduce the centre contact diameter (d) and insulator bore to around 0.6555 mm.

However, such a modification, whilst effective, gives rise to problems when users mis-mate 50 Ohm and 75 Ohm connectors. A common example is the N-Type RF connector. If a user is unaware and connects a 50 Ohm connector to a 75 Ohm connector, which is possible due to common external dimensions, the larger centre contact of the 50 Ohm connector will physically break the centre contact of the 75 Ohm connector.

In an effort to avoid such issues, connectors have alternatively been provided in which the mating dimensions are the same for both 50 and 75 Ohm connectors.

However, this has caused issues, since the front of the connector of the 75 Ohm connector must now be a larger diameter whilst the internals need to be reduced. One of the biggest design issues is how to support the smaller centre contact when the ends are larger, and how to fit the insulator.

One known solution has been to split the centre contact into two parts for push fitting together at assembly. This is not only difficult to manufacture and assemble, but it also places an unwanted discontinuity in the critical RF signal path which inevitably leads to a reduction in performance.

An alternative solution has been to introduce a lower dielectric such as Air (εᵣ=1), whereby the larger inner contact diameter may be balanced with a mix of different material dielectric constants to achieve the desired impedance. However, whilst this allows for the design of an insulator that can be easily slipped on from the front of a connector, and provides the support the contact requires, mixing different dielectrics again means introducing discontinuities into the critical signal path, since the signal will react to the different dielectrics and their values.

The present invention arose in a bid to provide an improved connector, obviating the drawbacks of the prior art.

Representative features are set out in the following clauses, which stand alone or may be combined, in any combination, with one or more features disclosed in the text and/or drawings of the specification.

According to the present invention in a first aspect, there is provided a coaxial connector comprising a body, which comprises an opening and a front portion for engaging with a corresponding connector, and a centre contact received within the opening of the body and supported by an insulator, wherein the insulator comprises an inner part comprising an opening defining an inner surface of the inner part that contacts an outer surface of the centre contact, and an outer part comprising an opening defining an inner surface of the outer part that contacts an outer surface of the inner part.

By virtue of such an arrangement, it is possible to provide a connector that is easily assembled, whilst offering improved performance by removing discontinuities. Whilst the insulator is formed of multiple parts, facilitating its insertion, upon assembly the multiple parts become one insulator again. An insulator can be provided that has one dielectric constant, and centrally holds and limits any movement of the centre contact.

Preferably, an outer surface of the outer part contacts an inner surface of the opening of the body.

Preferably, the inner part does not contact the inner surface of the opening of the body. The inner part is preferably spaced from the inner surface of the opening of the body by the outer part.

Preferably, there is no gap between the inner and outer parts, such that the insulator presents as a one-piece insulator. There is preferably no gap between the insulator and the centre contact or between the inner surface of the opening of the body and the insulator.

The inner and outer parts may be substantially the same length as one another. Front and rear edges of the inner and outer parts may be substantially coterminous with one another.

The centre contact may comprise a head provided in the front portion of the body, which has an increased diameter. The head may have an increased diameter compared to the remainder of the centre connector or compared to another part of the centre contact, which received the insulator. The insulator is preferably provided behind the head. An entirety of the insulator may be provided behind the head. The insulator may be provided immediately behind the head.

A minimum diameter of the opening in the outer part is preferably larger than the diameter of the head of the centre contact. The arrangement is preferably such that the head may pass through the opening of the outer part with a clearance between the head and the outer part at the minimum diameter of its opening.

The centre contact may have a reduced diameter portion, which receives the inner part. The reduced diameter portion may be provided immediately behind the head. The inner insulator may have substantially the same length as the reduced diameter portion.

Preferably, the outer surface of the inner part and the inner surface of the outer part are tapered. The tapered surfaces may taper towards the front of the connector.

The inner part is preferably formed such that it may be opened up along part or all of its length. The opening up of the inner part will aid in its attachment to the centre contact.

The inner part may comprise a radial split, which extends between the inner surface and an outer surface of the inner part. The radial split may extend along an entire length of the inner part.

The inner part may comprise a hinge.

The inner part may act to clamp the inner part closed against the centre contact.

Preferably, the centre contact is unitarily formed. The centre contact may be straight along its length or may be bent, such as at right angle.

Preferably, the body comprises a retention feature for engaging with the insulator or a retention member to restrict axial movement of the insulator.

The retention feature may comprise a shoulder, a groove or a barb.

Further, preferable, features are presented in the dependent claims.

Non-limiting embodiments of the invention will now be discussed with reference to the following drawings:

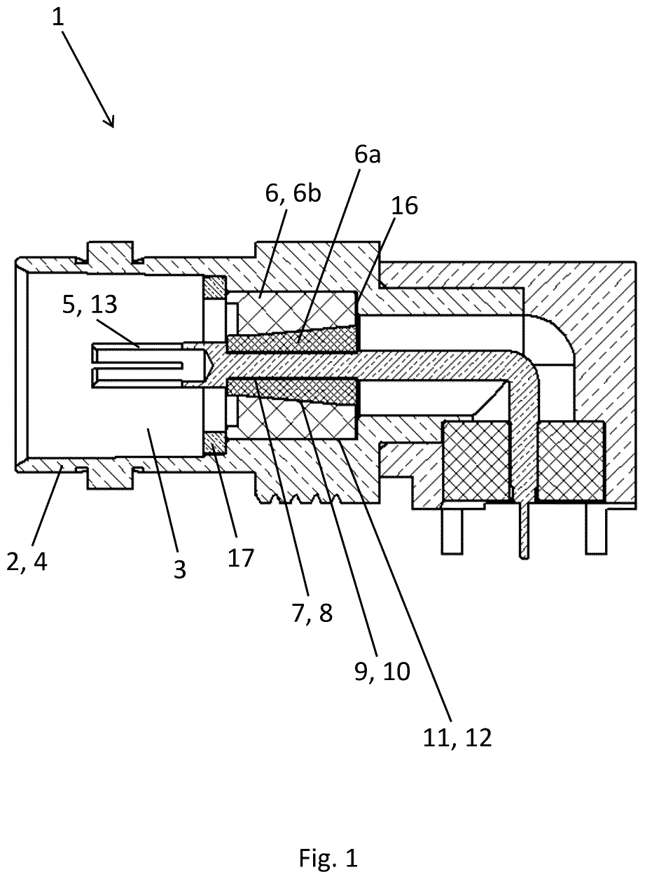

FIG. 1 shows a cross-sectional view of a coaxial connector according to a first embodiment;

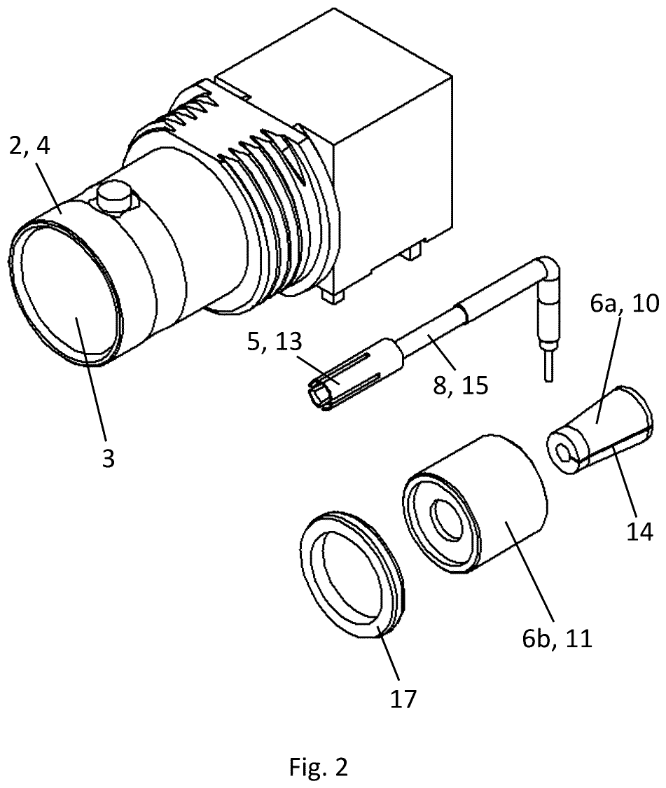

FIG. 2 shows a disassembled perspective view of the connector of FIG. 1;

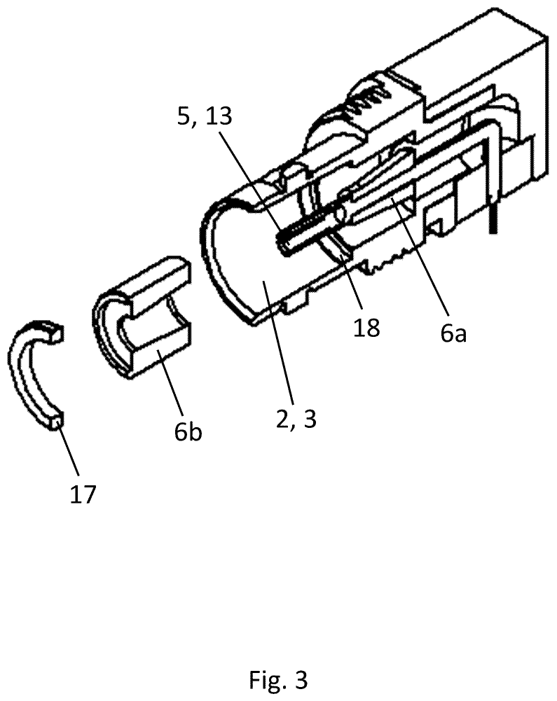

FIG. 3 shows a partial exploded cross-sectional perspective view of the connector of FIG. 1;

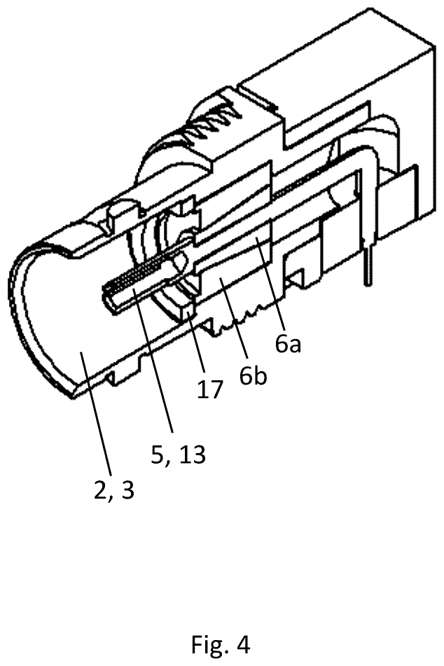

FIG. 4 shows a cross-sectional perspective view of the connector of FIG. 1;

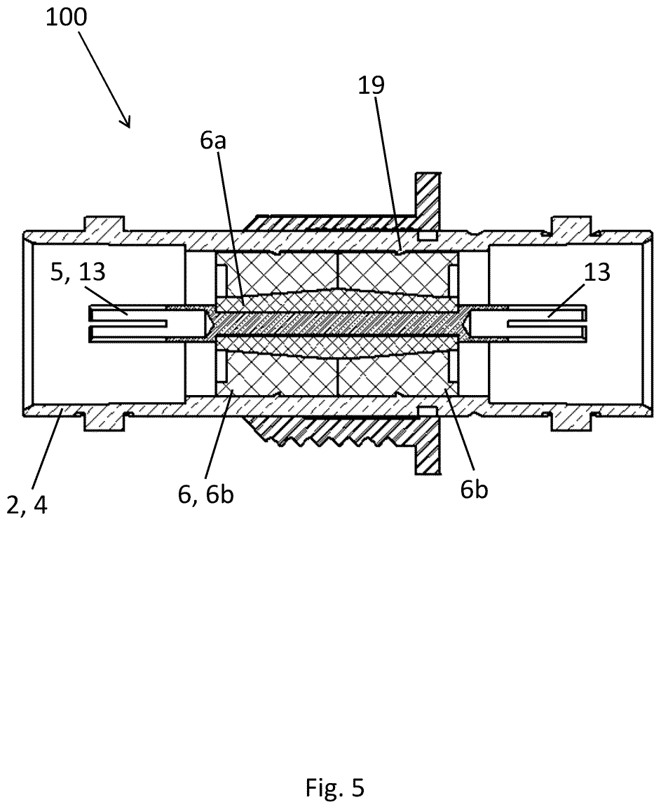

FIG. 5 shows a cross-sectional view of a coaxial connector according to a second embodiment; and

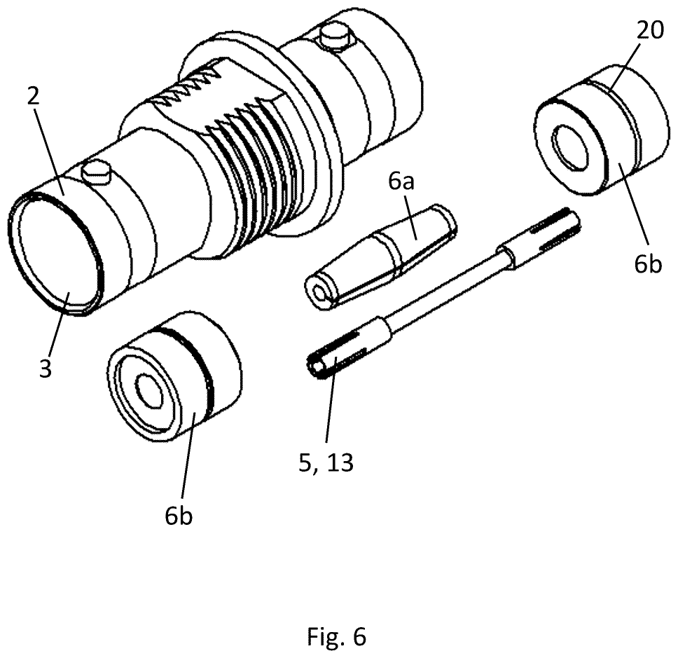

FIG. 6 shows a disassembled perspective view of the connector of FIG. 5.

With reference to FIGS. 1 to 4, there is shown a coaxial connector 1 according to a first embodiment. The coaxial connector 1 comprises a body 2, which comprises an opening 3 and a front portion 4 for engaging with a corresponding connector (not shown). A centre contact 5 is provided, which is received within the opening 3 of the body 2. The centre contact 5 is supported by an insulator 6, which comprises an inner part 6a and an outer part 6b. The inner part 6a comprises an opening (or bore) that defines an inner surface 7 of the inner part 6a that contacts an outer surface 8 of the centre contact 5. The outer part 6b comprises an opening (or bore) that defines an inner surface 9 of the outer part 6b that contacts an outer surface 10 of the inner part 6a.

The front portion 4 of the connector 1 is preferably substantially cylindrical, as best seen in FIG. 2. The housing 2 may be unitarily formed or may be formed from multiple pieces. The construction of the housing may vary in dependence on the specific form of the connector and/or operational requirements. The centre contact 5 is exposed in the opening 3 in the front portion 4 for suitable engagement with the corresponding connector. The centre contact 5 is preferably unitarily formed, as shown. This contrasts with prior art arrangements in which centre contacts are formed from multiple parts that are joined together during assembly. Whilst not limited as such, the connector may comprise a 75 Ohm RF connector. The connector may conform to BS EN 61169.

In the present arrangement, the insulator 6 is formed of only two parts. The first and second parts 6a, 6b are co-axial with one another, and with the centre contact 5 and the opening 3. In other arrangements, such as the embodiment discussed below with respect to FIGS. 5 and 6, for example, the insulator may comprise more parts. The number of parts will be dependent on the specific form of connector to be implemented.

Preferably, an outer surface 11 of the outer part 6b contacts an inner surface 12 of the opening 3 of the body 2. Preferably, the inner part 6a does not contact the inner surface 12 of the opening 3 of the body 2. The inner part 6a is preferably spaced from the inner surface 12 of the opening 3 of the body 2 by the outer part 6b.

The inner part 6a may be substantially the same length as the outer part 6b, as shown. Front and rear edges of the inner and outer parts 6a, 6b may be substantially coterminous with one another, as best seen in FIG. 1. However, the inner and outer parts 6a, 6b may be different lengths and/or comprise ends that are other than coterminous, particularly in arrangements that comprise more than two parts.

Regardless of the specific form of the insulator 6, it is preferable that when the insulator 6 is assembled and fully installed, as shown, for example, in FIGS. 1 and 4, it has a single dielectric constant. The inner and outer parts are preferably formed from the same material and have the same dielectric constant as one another. The inner and outer parts may be formed from plastic. The inner and outer parts may, for example, be formed from PTFE, polyoxymethylene (Delrin®), or polyetherimide (Ultem®), or otherwise. When assembled/installed there is no gap between the inner and outer parts, the insulator presents as a one-piece insulator. There is, moreover, preferably no gap between the insulator 6 and the centre contact 5 or between the inner surface 12 of the opening 3 of the body 2 and the insulator 6.

The outer surface 10 of the inner part 6a and the inner surface 9 of the outer part 6b may be tapered, as clearly shown. The inner part 6a may be substantially frustoconical in form, as best seen in FIG. 2. An opening in the outer part 6b, which forms the tapered inner surface 9 may be substantially frustoconical in form. Complementary tapered surfaces are particularly beneficial for preventing any gaps, as will be appreciated by those skilled in the art. The complimentary tapered faces are also beneficial for closing a slit in the inner part, as discussed below. It should be noted that the outer surface 10 of the inner part 6a and the inner surface 9 of the outer part 6b need not be tapered. They could, in alternative arrangements, be substantially parallel to the main axis of the connector.

For ease of assembly, when the surfaces are tapered, it is preferable that they taper towards the front of the connector. In such case, the outer part 6b may be easily installed by insertion into the opening 3 from the front of the connector. This is particularly beneficial for surface mount connectors comprising centre contacts 5 that are angled through 90 degrees, as seen in FIGS. 1 to 4. Regardless of the form of centre contact, however, assembly is simplified. With reference to FIG. 3, the inner part 6a may be put in place first. The outer part 6b may then be installed over the inner part 6a.

A minimum diameter of the opening in the outer part 6b is preferably larger than the diameter of the head 13 of the centre contact 5. The arrangement is preferably such that the head 13 may pass through the opening of the outer part 6b with a clearance between the head 13 and the inner surface 9 of the outer part 6b at the minimum diameter of the opening. This again enhances the assembly.

The inner part 6a is preferably formed such that it may be opened up along part or all of its length. The opening up of the inner part will aid in its attachment to the centre contact 5.

The inner part 6a, may comprise a radial split 14, which extends between the inner surface 7 and an outer surface 10 of the inner part 6a. The split, whilst not always required, allows for easier expansion of the opening of the inner part. The split may, for example, be omitted when a single ended straight centre contact 5 is used. When the radial split extends along an entire length of the inner part 6a, as seen, for example, in FIG. 2, the inner part 6a may be opened up into a C-shape (in end view). The inner part 6a may be clipped onto the centre contact 5, such as by the opening up of the inner part 6a and translation thereof in a direction substantially perpendicular to the axis of the centre contact 5 with the axes substantially parallel to one another. It should be noted that the split 14 may otherwise not extend for the length of the inner part 6a.

In alternative arrangements, the inner part 6a may be otherwise formed so that it has ends (in plan view) that are not connected but may be brought into contact with one another by compressing the inner part 6a. It need not be limited to an arrangement formed with a slit.

The inner part 6a may comprise a hinge, such that it may be opened up. Such an arrangement may be implemented, for example, if the inner part is formed by moulding. The hinge will preferably comprise a living hinge. The hinge may be formed during moulding of the inner part 6a.

The opening of the inner part 6a preferably has a diameter that is substantially equal to the diameter of the centre contact 5 in a region in which it is attached. The centre contact 5 may have a reduced diameter portion 15, as best seen in FIG. 2, which receives the inner part 6a. The reduced diameter portion 15 may be substantially the same length as the inner part 6a. Such an arrangement may prevent movement of the inner part 6a in the axial direction once it has been attached to the centre contact 5, such as shown in FIG. 3. The reduced diameter portion may be provided immediately behind the head 13. In alternative arrangements, the reduced diameter portion may be omitted.

There is preferably provided a retention feature for engaging with the insulator or a retention member for restricting axial movement of the insulator. The retention feature may take numerous forms, as will be readily appreciated by those skilled in the art, and there may be a number of retention features of the same form or a number of retention features having different forms to one another. Exemplary retention features comprise recesses and protrusions. Exemplary recesses may comprises grooves, indents, or otherwise. Exemplary protrusions may comprise shoulders, barbs, or otherwise.

With reference to FIGS. 1 to 4, there is provided a first retention feature in the form of a shoulder 16, which abuts the insulator 6 at a rear. A retention member 17 is provided at a front of the insulator, which is received by a retention feature 18 in the form of a groove. It should be appreciated that in place of the separate retention member, the outer insulator may, for example, have a modified form to incorporate the retention member.

The second embodiment, described below, utilises barbs 19 as the retention features. Barbs may be used in addition to, or in place of the above described retention features in the present embodiment.

Considering the depicted exemplary, non-limiting arrangement of FIGS. 1 to 4, installation of the insulator 6 may occur as follows:
1. The inner part 6a is attached to the centre contact 5 and the centre contact 5 is inserted into the opening 3 of the housing 2, as seen in FIG. 3.
2. The outer part 6b is inserted into the opening 3 from the front of the connector 1 and is pushed over the inner part 6a until it abuts the shoulder 16.
3. The retaining ring is 17 is inserted into the opening 3 from the front of the connector 1, and is seated in the groove 18, abutting the front of the insulator 6.

Of course, as will be appreciated, step 3 may not be required, or may be altered, in dependence on the form of the retention features implemented.

With reference to FIGS. 5 and 6, there is shown a second embodiment. Many of the features of the first embodiment are present in the second embodiment and like reference numerals are used. The description of the second embodiment will focus on the differences. It must be appreciated that, like the first embodiment, the second embodiment is exemplary and non-limiting. Moreover, it must be appreciated that features of the first and second embodiments may be combined. Discussion of a feature in the context of one embodiment only does not limit its use as such.

FIGS. 5 and 6 show a coaxial connector 100, which is double ended. The centre contact 5 is provided with an enlarged head 13 at each of its ends. The housing 2 is configured for engagement with corresponding connectors at its front and rear ends. The housing comprises an opening 3 that extends through the body 2. The centre contact 5 is again unitarily formed, as is preferred. The centre contact 5 is straight. In alternative arrangements, the centre contact 5 may be other than straight.

The Insulator 6 is formed in three parts. There is an inner part 6a and there are two outer parts 6b. An outer surface of the inner part 6a tapers from its centre towards its ends, and thereby towards the front and rear ends of the connector 100. Each of the outer parts 6b is provided with a complementary tapered inner surface, as best seen in FIG. 5. Each of the outer parts 6b is inserted through a respective end of the opening 3 of the housing. The outer parts 6b may have a combined length substantially equal to the length of the inner part 6a, as shown. The ends of the inner part 6a may be substantially coterminous with the ends of the outer parts 6b. In alternative arrangements, as will be appreciated from the discussion above, the tapers may be omitted and the inner and outer parts may not have coterminous ends.

As noted above, the second embodiment utilises barbs 19 as the retention features. The barbs 19 project from the inner surface defined by the opening 3. The outer parts 6b may comprise recesses 20 that receive the barbs. The recesses 20 may comprise grooves, as seen in FIG. 5.

It should be appreciated that insulators 6 comprising more than two parts may be implemented in arrangements that are other than double ended.

Numerous alternative arrangements and modifications to the embodiments as described herein will be readily appreciated by those skilled in the art within the scope of the appended claims. In particular, features of the described embodiments may be readily combined.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Although certain example embodiments of the invention have been described, the scope of the appended claims is not intended to be limited solely to these embodiments. The claims are to be construed literally, purposively, and/or to encompass equivalents.

1. A coaxial connector comprising a body, which comprises an opening and a front portion for engaging with a corresponding connector, and a centre contact received within the opening of the body and supported by an insulator, wherein the insulator comprises an inner part comprising an opening defining an inner surface of the inner part that contacts an outer surface of the centre contact, and an outer part comprising an opening defining an inner surface of the outer part that contacts an outer surface of the inner part.

2. A coaxial connector as claimed in claim 1, wherein an outer surface of the outer part contacts an inner surface of the opening of the body.

3. A coaxial connector as claimed in claim 2, wherein the inner part is spaced from the inner surface of the opening of the body by the outer part.

4. A coaxial connector as claimed in claim 1 wherein the inner and outer parts are substantially the same length as one another.

5. A coaxial connector as claimed in claim 1, wherein front and rear edges of the inner and outer parts are substantially coterminous with one another.

6. A coaxial connector as claimed in claim 1, wherein the centre contact comprises a head provided in the front portion of the body, which has an increased diameter.

7. A coaxial connector as claimed in claim 6, wherein a minimum diameter of the opening in the outer part is larger than the diameter of the head of the centre contact.

8. A coaxial connector as claimed in claim 7, wherein the insulator is provided behind the head.

9. A coaxial connector as claimed in claim 1, wherein the centre contact has a reduced diameter portion, which receives the inner part.

10. A coaxial connector as claimed in claim 9, wherein the inner part has substantially the same length as the reduced diameter portion.

11. A coaxial connector as claimed in claim 1, wherein the outer surface of the inner part and the inner surface of the outer part are tapered.

12. A coaxial connector as claimed in claim 11, wherein the tapered surfaces taper towards the front of the connector.

13. A coaxial connector as claimed in claim 1, wherein the inner part comprises a radial split, which extends between the inner surface and an outer surface of the inner part.

14. A coaxial connector as claimed in claim 13, wherein the radial split extends along an entire length of the inner part.

15. A coaxial connector as claimed in claim 1, wherein the centre contact is unitarily formed.

16. A coaxial connector as claimed in claim 1, wherein the body comprises a retention feature for engaging with the insulator or a retention member for restricting axial movement of the insulator.

17. A coaxial connector as claimed in claim 16, wherein the retention feature comprises a protrusion or recess.

18. A coaxial connector as claims in claim 16, wherein the retention features comprises one or more of a shoulder, a groove, or a barb.

19. A coaxial connector as claimed in claim 1, wherein the inner and outer parts are formed from the same material and the insulator has a single dielectric constant.

20. A coaxial connector as claimed in claim 1, wherein the inner and outer parts are formed from plastic, PTFE, polyoxymethylene, or polyetherimide.
